(19) United States
(12) Patent Application Publication
(10) Pub. No.: US 2022/0023826 A1
(43) Pub. Date: Jan. 27, 2022

(54) METHOD OF PREPARING AN ADSORPTION MATERIAL FOR A VAPORIZER

(71) Applicants: Ben Wen, Herndon, VA (US); Adela Alas, Falls Church, VA (US)

(72) Inventors: Ben Wen, Herndon, VA (US); Adela Alas, Falls Church, VA (US)

(21) Appl. No.: 16/934,942

(22) Filed: Jul. 21, 2020

(51) Int. Cl. B01J 20/04; B01J 20/02; B01J 20/28; B01J 20/30

(52) U.S. Cl. CPC B01J 20/041; B01J 20/02; B01J 20/2803; B01J 20/28004; B01J 20/3078; B01J 20/28011; B01J 20/3042; B01J 20/3064; B01J 20/3014; B01J 20/28085

(57) ABSTRACT

A method of preparing a porous and permeable adsorption material for a vaporizer utilizes a mixing step; a kneading step; a molding step; a drying step; a first holding step; a calcining step; a second holding step; a forming step; a third holding step; and a producing step. The raw materials include particulates of silicon carbide of 50-85 weight percent, a binder of 1-30 weight percent, a pore forming agent of 5-35 weight percent, and a surfactant of 0.15-7.5 weight percent. Once these raw material components are mixed, then adding water of 5 weight percent to 35 weight percent while kneading to form a wetted mixture of raw materials. The remaining steps describe a molding and heating regimen.

### TECHNICAL FIELD

In the field of compositions of matter, a porous and permeable adsorption material useful in promoting a phase change from liquid to gas inside the pores of the porous and permeable adsorption material.

### BACKGROUND ART

Porous and permeable adsorption material is an important component of any vaporizing device that is used to vaporize oils or other liquids (referred to as a liquid) for medical or recreational use. A vaporizing device generally includes a reservoir containing the liquid, a battery power sources, and a heating component. The liquid is drawn to the heating component that is powered by the battery, and is in contact with or proximal to heating component wherein the liquid is vaporized and subsequently mixed with air prior to a user's inhalation.

The heating component consists of a heating wire element and a solid adsorption material wherein the heating wire element is embedded in, wrapped around, or in other direct or proximal contact with the solid adsorption material. The heating wire element is generally ohmic resistance heating wire made of metal alloys of nickel and chromium capable of operation up to 1200 degrees Centigrade under oxidizing conditions.

The adsorption material is generally a porous cylindrical body capable of drawing the liquid into the pores of the adsorption material through capillary force and temporarily holding the liquid inside the pores prior to vaporization. The adsorption material is heated up to required temperatures by the heating wire element through direct heat transfer from the heating wire to the adsorption material.

Thermal conductivity is an important property of adsorption materials used in the field of vaporizing devices. Thermal conductivity is the amount of heat passing in unit time through unit surface in a direction normal to this surface when this transfer is driven by a unit temperature gradient under steady state conditions. Unlike metals, ceramics materials such as cordierite, glass, and quartz have low thermal conductivity due to ionic-covalent bonding that does not form free electrons.

Low thermal conductivity slows the dissipation of the heat generated from the heating element to the adsorption material, leading to non-uniform temperature distribution within the adsorption material with higher temperature in the areas closer to the heating element and much lower temperature in the locations far from the heating element. The use of the vaporizing devices with low thermal conductivity adsorption materials gives rise to the localized overheating or burning of some low boiling point components of the liquid and results in unfavorable burnt flavor and health-related issues due to the decomposition or degradation of active components of the liquid. On the other hand, the low temperatures in the locations far from the heating elements are insufficient to cause the vaporization of some high boiling point components in the liquid, leading to incomplete vaporization of the liquid, impure taste, and liquid run-away and leakage.

In contrast to the thermal conductivities of 1.3 Watts per meter degree Kelvin for non-crystalline fused silica glass, 6.1 Watts per meter degree Kelvin for crystalline silica quartz, and 3.0 Watts per meter degree Kelvin for cordierite ceramics at room temperature, silicon carbide material has a thermal conductivity of 262 Watts per meter degree Kelvin. This unique thermal property of silicon carbide material enables a rapid heat transfer from the heating wire element to the entire body of the porous silicon carbide absorption material disclosed herein. They further promote a uniform temperature distribution within the adsorption material independent of the location relative to the heating wire element.

Some liquid plant oils have over 100 chemical components or strains with each component having a boiling temperature in the range from 21 to 200 degrees Centigrade. The wide chemical profile of a liquid oil emphasizes the importance to achieve rapid heat transfer and uniform temperature distribution within the entire adsorption material body to ensure the preservation of the natural flavor profile and health effects as well as avoidance of undesirable taste by inhalation.

### SUMMARY OF INVENTION

A method of preparing a porous and permeable adsorption material for a vaporizer utilizes a mixing step; a kneading step; a molding step; a drying step; a first holding step; a calcining step; a second holding step; a forming step; a third holding step; and a producing step. The mixing step is creating a mixture of raw materials that includes particulates of silicon carbide of 50-85 weight percent, a binder of 1-30 weight percent, a pore forming agent of 5-35 weight percent, and a surfactant of 0.15-7.5 weight percent. Once these raw material components are mixed, then adding water of 5 weight percent to 35 weight percent while kneading to form a moldable mixture.

The moldable mixture is subsequently molded, preferably pressure extruded, to form a shaped body, also referred to as a green body. The shaped body is then heated at a heating rate of 0.5-2.5 degrees Centigrade per minute to a drying temperature between 120 and 200 degrees Centigrade. Then holding at the drying temperature for 2-10 hours. Then, raising the drying temperature to a calcination temperature of 550-650 degrees Centigrade at heating rate of 1 to 6 degrees Centigrade per minute. Then, holding the calcination temperature for 1 to 5 hours, after which increasing the calcination temperature to a final forming temperature at 750-1100 degrees Centigrade at a heating rate of 1 to 15 degrees Centigrade per minute. Then, maintaining the final forming temperature for 0.5 to 5 hours. Finally, cooling the shaped body to room temperature to produce a porous and permeable adsorption material.

Optional steps and limitations on the method include: limiting the average diameter of each particle in the silicon carbide particulate to less than 250 microns or to less than 150 microns; limiting the mass amount of the silicon carbide particulate in the adsorption material to 70 weight percent or greater or 80 weight percent or greater; limiting the binder to an inorganic binder having a melting temperature lower than 1250 degrees Centigrade or lower than 1100 degrees Centigrade; or lower than 1000 degrees Centigrade; confining the binder to particulate form of less than 20 microns and selected from the group consisting of sodium carbonate, calcium carbonate, and sodium silicate; limiting the mass amount of the binder to between 5 and 30 weight percent; discarding the porous and permeable adsorption material produced when the average pore size diameter is outside the range of 10 to 250 microns; discarding the porous and permeable adsorption material produced when the porosity is outside the range of 15 to 65 percent; discarding the porous and permeable adsorption material produced when the compressive strength is lower than 2 megapascals; selecting the binder from an inorganic particulate consisting of an oxide having a melting temperature lower than 1250 degrees Centigrade and having particle diameter less than 20 microns; selecting the binder from an inorganic particulate consisting of an oxide having a melting temperature lower than 1000 degrees Centigrade and having particle diameter less than 5 microns; selecting the pore forming agent from the group consisting of starch, cellulose, carbon or coal powder, wood powder and fiber, resin, polymer, graphite; limiting the pore forming agent to a particle having an average diameter in a range of 10 to 250 micrometers; limiting the pore forming agent to a particle having an average diameter in a range of 20 to 120 micrometers; selecting the surfactant from the group consisting of sodium dodecylbenzene sulfonates, polyvinyl alcohol, carboxymethyl cellulose, ethylene glycol, and polyoxyalkyl ether; and embedding a heating wire into the shaped body when molding the wetted mixture of raw materials into the shaped body.

### Technical Problem

Existing adsorption materials, such as porous ceramic, fritted glass, and porous quartz, used in vaporizing devices have the disadvantage with very low thermal conductivities, generally in the ranges of 0.5 to 5.5 W·m−1·K−1 at 25 degrees Centigrade, resulting in poor heat transfer between the heating wire element and the said adsorption material and non-uniform and uneven temperature distribution within the adsorption material, and poor taste of the vapor by inhalation.

Existing silicon carbide materials have issues such as high preparation temperatures, they are insufficiently porous, and there are typically high production costs that limit their use in vaporizing devices.

In order to achieve uniform temperature distribution within the adsorption material, which eliminates hot spots or localized temperature spikes and ensures even and controlled vaporization of the liquid, the adsorption material should have high thermal conductivity in order to dissipate the heat generated from the wire element to the adsorption material rapidly and uniformly and generate vapor with favorable properties, including taste and flavor.

### Solution to Problem

The solution is a method of making a composition of matter by combining silicon carbide powder, binder, a pore-forming agent, and surfactant particles in specified weight percentages then mixing with water and heating in a specific manner. In a molding step, the silicon carbide powder becomes bonded with a low melting-temperature inorganic binder. The end product has micro-size interconnected pores that are widely distributed to deliver enhanced porosity. The pores and structured supporting walls between the pores deliver mechanical strength and thermal conductivity for vaporizing applications. The method produces the porous and permeable adsorption material with simple pressing and low production costs for practical vaporizing applications.

### Advantageous Effects of Invention

The method of making disclosed herein is for a composition of matter useful as a liquid adsorption material, such as in a vaporizer or in vaporizing device applications. The porous and permeable adsorption material produced by the method disclosed permits a liquid to enter and permeate its pores where the liquid can be heated and converted to a gaseous state that is then easily passed through the porous and permeable adsorption material.

The porous and permeable adsorption material disclosed herein solves technical shortcomings in prior art compositions of matter involving high preparation temperatures, insufficient porosity, and high production costs that limit their use in vaporizing devices. The composition of matter disclosed herein provide a preparation method for a porous and permeable adsorption material having high thermal conductivity, high porosity, and low production costs for vaporizing devices applications.

In addition to the high thermal conductivity, the disclosed porous and permeable adsorption material is of the following critical physical properties: optimized pore sizes and pore size distribution, controlled porosity, and well-connected pores and permeability.

The pore sizes and pore size distribution of the porous and permeable adsorption material are optimized within the specific narrow ranges (pore size distribution) with pre-determined capillary forces that are able to draw the viscous liquid into the pores of the adsorption material and hold/store the liquid inside the pores at room temperature without the ability leaving the pores and causing leakage. When heat is applied and the liquid changes to vapor and leaves the pores, the liquid in the reservoir is drawn into the pores continuously.

The porosity of the porous and permeable adsorption material is well controlled to maximize the production of the vapor with desired flavor and healthy effects. The porosity of an adsorption material is defined as the fraction of empty space in its volume that determines the volume of the liquid drawn into and stored inside the adsorption body and the amount of vapor achieved. The porosity needs to be controlled in order to achieve uniform heating and total vaporization of the liquid. The porosity also affects the mechanical strength of the adsorption material.

The porous and permeable adsorption material disclosed herein has controlled permeability that is related to the porosity, pore size distribution, and interconnectivity of the pores. The permeability of the same adsorption material is different for liquid and for its vapor. The porosity and pore size distribution of the disclosed porous and permeable adsorption material produce optimized permeability for the liquid and its vapor.

In addition to the above properties, porous and permeable adsorption material disclosed herein has other desirable properties for vaporizing device applications, including high mechanical strength, low dielectric constant, low coefficient of thermal expansion, high wear resistance and chemical corrosion resistance, small specific gravity, high thermal shock resistance, simple processing methodology and low production cost.

The disclosed porous and permeable adsorption material eliminates the limitations in the prior art and allow users to inhale the vapor for recreational or medicinal purposes without the consequences of health and undesirable taste issues associated with existing vaporizing devices.

### BRIEF DESCRIPTION OF DRAWINGS

The drawings illustrate preferred embodiments of the method of preparing an adsorption material for a vaporizer according to the disclosure. The reference numbers in the drawings are used consistently throughout. New reference numbers in FIG. 2 are given the 200 series numbers. Similarly, new reference numbers in each succeeding drawing are given a corresponding series number beginning with the figure number.

FIG. 1 is a flow diagram illustrating preferred steps in a method of making the porous and permeable adsorption material.

FIG. 2 is flow diagram of optional steps in the method.

FIG. 3 is flow diagram of optional steps in the method.

FIG. 4 is flow diagram of optional steps in the method.

### DESCRIPTION OF EMBODIMENTS

In the following description, reference is made to the accompanying drawings, which form a part hereof and which illustrate the steps of a preferred method disclosed herein. The drawings and the preferred embodiments of the method taught herein are presented with the understanding that the present invention is susceptible to operational changes that may be made as taught herein.

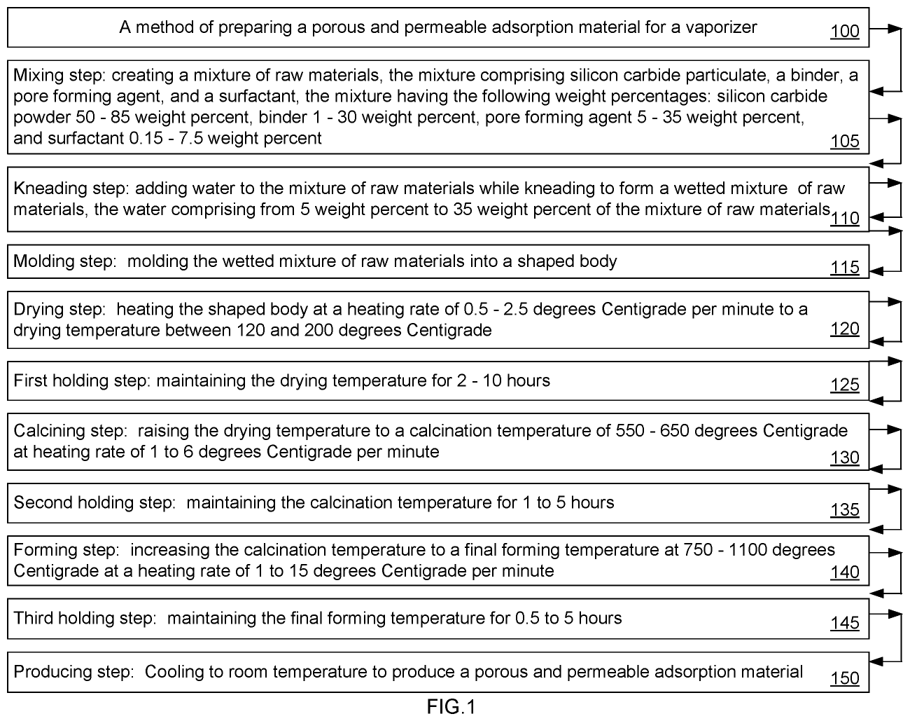

FIG. 1 illustrates preferred steps in a method (100) of preparing a porous and permeable adsorption material for a vaporizer. This method has at least the following steps: A mixing step (105); a kneading step (110); a molding step (115); a drying step (120); a first holding step (125); a calcining step (130); a second holding step (135); a forming step (140); a third holding step (145); and a producing step (150).

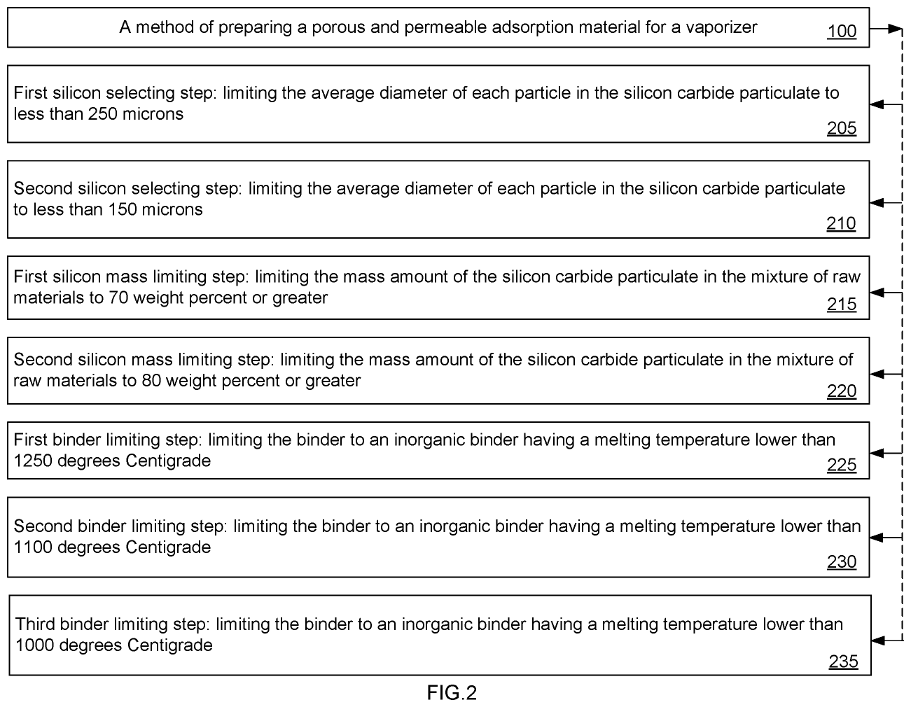

FIG. 1 is a flow diagram where the arrows indicate a sequential order to the steps in the process. An arrow into a box shows that the prior step's result is needed prior to performing that step. An arrow out of the box indicates that the result of the step is provided to the next step. In contrast, in FIGS. 2-4, the arrows only go into a box with a step and the arrows originate from a dashed line, indicating that any such step is optional in the process.

FIG. 2 illustrates additional and optional steps in the method (100) of preparing a porous and permeable adsorption material for a vaporizer, which include a first silicon selecting step (205); a second silicon selecting step (210); a first silicon mass limiting step (215); a second silicon mass limiting step (220); a first binder limiting step (225); a second binder limiting step (230); and a third binder limiting step (235).

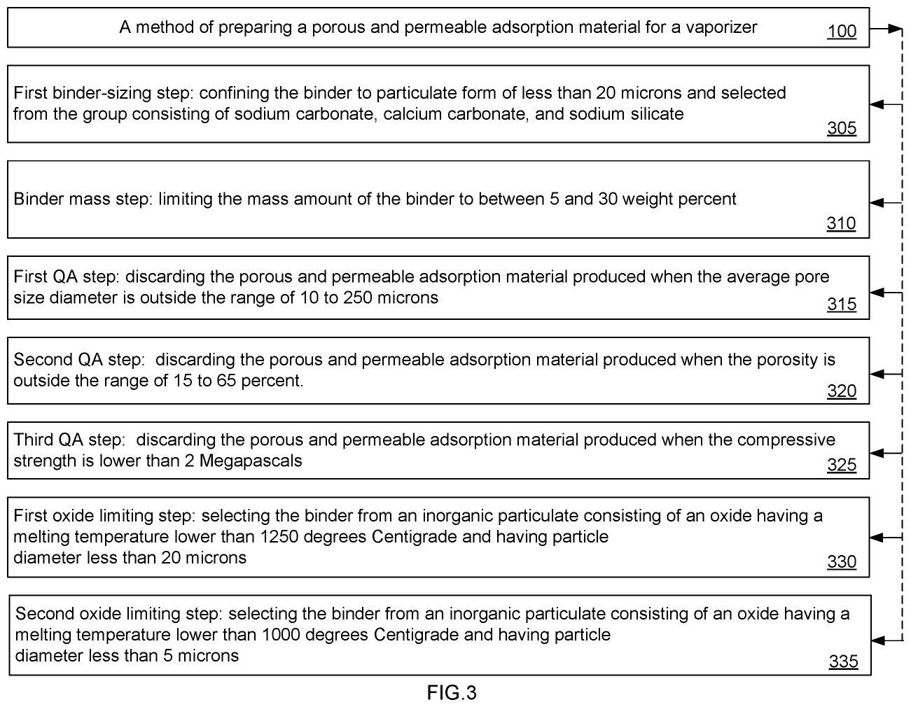

FIG. 3 illustrates additional and optional steps in the method (100) of preparing a porous and permeable adsorption material for a vaporizer, which include a first binder-sizing step (305); a binder mass step (310); a first QA step (315); a second QA step (320); a third QA step (325); a first oxide limiting step (330); and a second oxide limiting step (335).

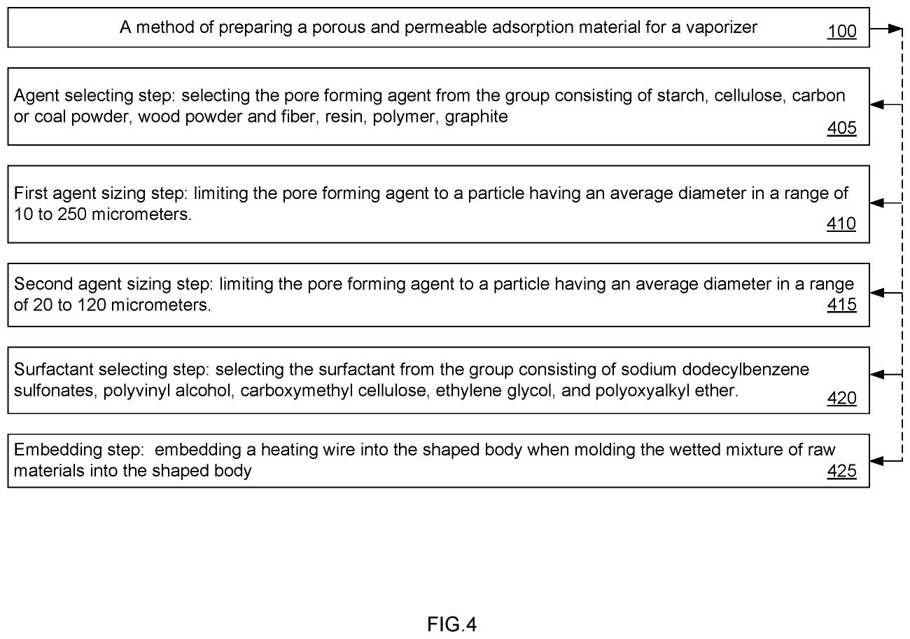

FIG. 4 illustrates additional and optional steps in the method (100) of preparing a porous and permeable adsorption material for a vaporizer, which include an agent selecting step (405); a first agent sizing step (410); a second agent sizing step (415); and an embedding step (425).

Regarding FIG. 1, the mixing step (105) includes creating a mixture of raw materials, the mixture comprising silicon carbide particulate, a binder, a pore forming agent, and a surfactant, the mixture having the following weight percentages: silicon carbide powder 50-85 weight percent, binder 1-30 weight percent, pore forming agent 5-35 weight percent, and surfactant 0.15-7.5 weight percent.

In FIG. 2, the first silicon selecting step (205) is an optional step that requires limiting the average diameter of each particle in the silicon carbide particulate to less than 250 microns. The silicon carbide particulate is preferably a fine particulate in the form of a powder. Generally, the finer the powder, the smaller the pores created in the press. Thus, a second silicon selecting step (210) in FIG. 2 is limiting the average diameter of each particle in the silicon carbide particulate to less than 150 microns.

The existence of larger size silicon carbide particles typically gives rise to the formation of large pores which is not preferred in terms of the physical and thermal properties required for the porous and permeable adsorption material. The mass amount of the silicon carbide particles in the porous and permeable adsorption material is preferably over 70 weight percent. Thus, the first silicon mass limiting step (215) in FIG. 2, which is optional is limiting the mass amount of the silicon carbide particulate to 70 weight percent or greater.

More preferably, the mass amount of silicon carbide particulate is over 80 weight percent. Thus, the second silicon mass limiting step (220) in FIG. 2, which is optional, is limiting the mass amount of the silicon carbide particulate to 80 weight percent or greater.

The thermal conductivity of the final product may be altered by the amount of the silicon carbide particles in the porous and permeable adsorption material: Generally, the higher the weight percent of silicon carbide, the higher the thermal conductivity of the final product.

The porous and permeable adsorption material preferably contains an inorganic binder having a low melting temperature that bonds the silicon carbide particulate together to form an integrated structured body. Exemplary inorganic binders are sodium carbonate, calcium carbonate, sodium silicate or a mixture of these. The binder preferably has particle size less than 20 microns, preferably less than 5 microns. Thus, the first binder-sizing step (305) in FIG. 3, which is optional, requires confining the binder to particulate form of less than 5 microns and selected from the group consisting of sodium carbonate, calcium carbonate, and sodium silicate.

The amount of the binder in the porous and permeable adsorption material is preferably less than 30 weight percent, more preferably between 5 and 30 weight percent. Thus, the binder mass step (310) in FIG. 3 requires limiting the mass amount of the binder to between 5 and 30 weight percent.

Within these limits, lower binder amounts deliver lower mechanical strengths of the porous and permeable adsorption material, while higher binder amounts causes a decrease in the thermal conductivity of the porous and permeable adsorption material.

The melting temperature of the binder is preferably lower than 1250 degrees Centigrade, which is a typical melting temperature of a heating wire element that may be used in an application to vaporize a liquid within the pores of the final product. Thus, the first binder limiting step (225), which is optional, requires limiting the binder to an inorganic binder having a melting temperature lower than 1250 degrees Centigrade. Optionally, this temperature limitation may also be combined with a particle diameter limitation when the binder is an inorganic and composed of an oxide. Thus, the first oxide limiting step (330) in FIG. 3 requires selecting the binder from an inorganic particulate consisting of an oxide having a melting temperature lower than 1250 degrees Centigrade and having particle diameter less than 20 microns.

Preferably, the binder has a melting temperature lower than 1100 degrees Centigrade. Thus, the second binder limiting step (230), which is optional, requires limiting the binder to an inorganic binder having a melting temperature lower than 1100 degrees Centigrade. Optionally, this temperature limitation may also be combined with a particle diameter limitation when the binder is an inorganic and composed of an oxide. Thus, the second oxide limiting step (335) in FIG. 3 requires selecting the binder from an inorganic particulate consisting of an oxide having a melting temperature lower than 1000 degrees Centigrade and having particle diameter less than 5 microns.

More preferably, the meting temperature of the binder is less than 1000 degrees Centigrade. Thus, the third binder limiting step (235), which is optional, requires limiting the binder to an inorganic binder having a melting temperature lower than 1000 degrees Centigrade.

The kneading step (110) is adding water to the mixture of raw materials while kneading to form a wetted mixture of raw materials, the water comprising from 5 weight percent to 35 weight percent of the mixture of raw materials. The kneading step (110) makes a moldable body from a mixture that is essentially composed of dry particulates. The amount of water added determines the moldability of the mixture: Within limits, more water makes the mixture more malleable and conducive to being shaped into a final form. However, too much water will prevent the mixture from holding the desired end shape. The kneading step (110) preferably adds water to the mixture in an amount equal to 5 weight percent to 35 weight percent, preferably 15 to 25 weight percent.

At the conclusion of the kneading step (110), that is, after the water is added and the mixture thoroughly kneaded, the resulting wetted mixture of raw materials is in a condition to be molded into a desired product shape.

The next step is the molding step (115) and this step includes molding the wetted mixture of raw materials into a shaped body, also referred to as a green body. Molding is preferably done with a press where mechanical pressure can be applied. For example, extrusion is a preferred molding method when a pipe or tubular shape is desired.

The embedding step (425) includes the step of embedding a heating wire into the shaped body when molding the wetted mixture of raw materials into the shaped body. This optional step permits a heating wire element to be embedded into the shaped body, most easily when the kneaded material is pressure molded. The heating wire element holds its shape and properties during the drying step (120) and also during the calcining step (130).

The porous and permeable adsorption material may be molded into different shapes, and cylindrical and rectangular shapes are the most common. The porous and permeable adsorption material has compressive strength over 2 megapascals, preferably over 10 megapascals for the vaporizing device applications. Thus, the third QA step (325) in FIG. 3, which is optional, requires discarding the porous and permeable adsorption material produced when the compressive strength is lower than 2 megapascals.

The compressive strength of the porous and permeable adsorption material directly relates to the porosity, pore size distribution, and the composition of the material including the binding effect.

The drying step (120) includes heating the shaped body at a heating rate of 0.5-2.5 degrees Centigrade per minute to a drying temperature between 120 and 200 degrees Centigrade. This step removes the majority of the water.

The first holding step (125) includes maintaining the drying temperature for 2-10 hours.

The calcining step (130) includes raising the drying temperature to a calcination temperature of 550-650 degrees Centigrade at heating rate of 1 to 6 degrees Centigrade per minute. The calcining step (130) removes the pore forming agent and creates the pores. This calcination temperature is lower than the melting temperature of the binder.

The second holding step (135) includes maintaining the calcination temperature for 1 to 5 hours.

The drying step (120) and the calcining step (130) are preferably performed in air under an oxidizing atmosphere.

The forming step (140) includes increasing the calcination temperature to a final forming temperature at 750-1100 degrees Centigrade at a heating rate of 1 to 15 degrees Centigrade per minute.

The third holding step (145) includes maintaining the final forming temperature for 0.5 to 5 hours. The third holding step (145) melts the binder and bonds the silicon carbide particles to form a porous and permeable adsorption material that is an integral unit.

The producing step (150) includes cooling to room temperature to produce a porous and permeable adsorption material, which has well interconnected open-ended pores with average pore size in the range of 10 to 250 microns, preferably 20 to 120 microns. Thus, an optional quality assurance test of the final product manifests in a first QA step (315) in FIG. 3, which requires discarding the porous and permeable adsorption material produced when the average pore size diameter is outside the range of 10 to 250 microns.

These open-ended optimized pores provide a capillary force to draw in liquid with different viscosities into the pores and store the liquid inside without leaking out of the pores at room temperature.

The porous and permeable adsorption material typically has a porosity in the range of 15% to 65%, preferably 20 to 55%. The porosity determines the volume of the liquid that stores in the pores and the amount of vapor could be produced.

The porosity affects the mechanical strength of the porous and permeable adsorption material which may be optimized to achieve a desired strength for vaporizing device applications. Thus, the second QA step (320) in FIG. 3 requires discarding the porous and permeable adsorption material produced when the porosity is outside the range of 15 to 65 percent.

In addition, the porosity relates to the thermal conductivity of porous and permeable adsorption material. With an increase in porosity, the thermal conductivity of the porous and permeable adsorption material decreases. Porosity may be considered an important property for the porous and permeable adsorption material, and the method disclosed permits optimizing the porosity.

The pore forming agent is preferably one or more of organic compounds selected from starch, cellulose, carbon or coal powder, wood powder or fiber, resin, polymer, and graphite. The agent has an average particle size in the range of 10 to 250 microns, preferably 20 to 120 microns with a narrow particle size distribution. The particle sizes of the forming agent determine the sizes and shapes of the pores. The amount of the pore forming agent affects the number of the pores and the porosity of the porous and permeable adsorption material.

The preferred surfactant is sodium dodecylbenzene sulfonates that has been widely in the areas of cosmetics, food, cleansing products. Other surfactants include polyvinyl alcohol, carboxymethyl cellulose, ethylene glycol, polyoxyalkyl ether, may also be used. The surfactant reduces the surface tensions of the fine particles and assists in the homogeneous mixing and distribution of the particles.

### Example 1

In a first example of the method of making or preparing a porous and permeable adsorption material for a vaporizer, a mixture was made of 100 grams of silicon carbide with an average particle size of 120 microns, 9 grams of sodium carbonate with an average particle size of 2.6 microns, 32 grams of corn starch with an average particle size of 38 microns, and 3 grams of sodium dodecylbenzene sulfonates. Then, 35 grams of water was added to the mixture while the mixture was kneaded for 20 minutes. Then, the wet mixture was molded into a cylindrically-shaped body by extrusion using a pressure of 5 megapascals. The cylindrically-shaped body was then placed in a heating furnace under atmospheric environment and heated to 120 degrees Centigrade at a heating rate of 0.5 degrees Centigrade per minute. The heated cylindrically-shaped body was held at 120 degrees Centigrade for 2 hours. Then, the temperature in the furnace holding the cylindrically-shaped body was raised to 600 degrees Centigrade at a heating rate of 2 degrees Centigrade per minute. When the temperature in the furnace holding the heated cylindrically-shaped body reached 600 degrees Centigrade, this temperature was held for 3 hours. Subsequently, the temperature was further increased to 900 degrees Centigrade at 2 degrees Centigrade per minute. When the temperature in the furnace holding the heated cylindrically-shaped body reached 900 degrees Centigrade, this temperature was held for 1 hour. After cooling to room temperature, the desired silicon carbide adsorption material was obtained.

### Example 2

In a first example of the method of making or preparing a porous and permeable adsorption material for a vaporizer, a mixture was made of 100 grams of silicon carbide with an average particle size of 80 microns, 6 grams of calcium carbonate with an average particle size of 4.0 microns, 15 grams of wood fiber with an average diameter of 85 microns and an average length of 300 microns, and 2 grams of sodium dodecylbenzene sulfonates. Then, 25 grams of water was added while kneading the wetted mixture for 30 minutes. Then, the wet mixture was molded into a cylindrically-shaped body by extrusion under a pressure of 15 megapascals. The cylindrically-shaped body was then placed in a heating furnace under atmospheric environment and heated to 160 degrees Centigrade at a heating rate of 1.0 degrees Centigrade per minute. When the temperature in the furnace reached 160 degrees Centigrade, this temperature was held for 1.5 hours. Then, the temperature in the furnace holding the cylindrically-shaped body was raised to 700 degrees Centigrade at a heating rate of 5 degrees Centigrade per minute. When the temperature in the furnace reached 700 degrees Centigrade, the cylindrically-shaped body was held at this temperature for 2 hours. Subsequently, the temperature was further increased to 875 degrees Centigrade at 5 degrees Centigrade per minute and kept at 875 degrees Centigrade for 1.5 hours. After cooling to room temperature, the silicon carbide adsorption material was obtained.

The above-described embodiments including the drawings are examples of the invention and merely provide illustrations of the orthotic foot rest for a pedaling machine. Other embodiments will be obvious to those skilled in the art. Thus, the scope of the invention is determined by the appended claims and their legal equivalents rather than by the examples given.

### INDUSTRIAL APPLICABILITY

The invention has application to the vaporization industry.

What is claimed is:

1. A method of preparing a porous and permeable adsorption material for a vaporizer, the method comprising the steps of:
creating a mixture of raw materials, the mixture comprising: a silicon carbide particulate; a binder; a pore forming agent; and a surfactant; the mixture having the following weight percentages: silicon carbide powder 50-85 weight percent, binder 1-30 weight percent, pore forming agent 5-35 weight percent, and surfactant 0.15-7.5 weight percent;
adding water to the mixture of raw materials while kneading to form a wetted mixture of raw materials, the water comprising from 5 weight percent to 35 weight percent of the mixture of raw materials;
molding the wetted mixture of raw materials into a shaped body;
heating the shaped body at a heating rate of 0.5-2.5 degrees Centigrade per minute to a drying temperature between 120 and 200 degrees Centigrade;
maintaining the drying temperature for 2-10 hours;
raising the drying temperature to a calcination temperature of 550-650 degrees Centigrade at heating rate of 1 to 6 degrees Centigrade per minute;
maintaining the calcination temperature for 1 to 5 hours;
increasing the calcination temperature to a final forming temperature at 750-1100 degrees Centigrade at a heating rate of 1 to 15 degrees Centigrade per minute;
maintaining the final forming temperature for 0.5 to 5 hours; and
cooling to room temperature to produce a porous and permeable adsorption material.

2. The method of claim 1, further comprising the step of limiting an average diameter of each particle in the silicon carbide particulate to less than 250 microns.

3. The method of claim 1, further comprising the step of limiting an average diameter of each particle in the silicon carbide particulate to less than 150 microns.

4. The method of claim 1, further comprising the step of limiting a mass amount of the silicon carbide particulate in the mixture of raw materials to 70 weight percent or greater.

5. The method of claim 1, further comprising the step of limiting a mass amount of the silicon carbide particulate in the mixture of raw materials to 80 weight percent or greater.

6. The method of claim 1, further comprising the step of limiting the binder to an inorganic binder having a melting temperature lower than 1250 degrees Centigrade.

7. The method of claim 1, further comprising the step of limiting the binder to an inorganic binder having a melting temperature lower than 1100 degrees Centigrade.

8. The method of claim 1, further comprising the step of limiting the binder to an inorganic binder having a melting temperature lower than 1000 degrees Centigrade.

9. The method of claim 1, further comprising the step of confining the binder to particulate form of less than 20 microns and selected from the group consisting of sodium carbonate, calcium carbonate, and sodium silicate.

10. The method of claim 1, further comprising the step of limiting a mass amount of the binder to between 5 and 30 weight percent.

11. The method of claim 1, further comprising the step of discarding the porous and permeable adsorption material produced when an average pore size diameter is outside a range of 10 to 250 microns.

12. The method of claim 1, further comprising the step of discarding the porous and permeable adsorption material produced when its porosity is outside a range of 15 to 65 percent.

13. The method of claim 1, further comprising the step of discarding the porous and permeable adsorption material produced when its compressive strength is lower than 2 megapascals.

14. The method of claim 1, further comprising the step of selecting the binder from an inorganic particulate consisting of an oxide having a melting temperature lower than 1250 degrees Centigrade and having particle diameter less than 20 microns.

15. The method of claim 1, further comprising the step of selecting the binder from an inorganic particulate consisting of an oxide having a melting temperature lower than 1000 degrees Centigrade and having particle diameter less than 5 microns.

16. The method of claim 1, further comprising the step of selecting the pore forming agent from the group consisting of starch, cellulose, carbon or coal powder, wood powder and fiber, resin, polymer, graphite.

17. The method of claim 1, further comprising the step of limiting the pore forming agent to a particle having an average diameter in a range of 10 to 250 micrometers.

18. The method of claim 1, further comprising the step of limiting the pore forming agent to a particle having an average diameter in a range of 20 to 120 micrometers.

19. The method of claim 1, further comprising the step of selecting the surfactant from the group consisting of sodium dodecylbenzene sulfonates, polyvinyl alcohol, carboxymethyl cellulose, ethylene glycol, and polyoxyalkyl ether.

20. The method of claim 1, further comprising the step of embedding a heating wire into the shaped body when molding the wetted mixture of raw materials into the shaped body.
